(19) United States
(12) Patent Application Publication
(10) Pub. No.: US 2014/0141205 A1
(43) Pub. Date: May 22, 2014

(54) METHOD FOR PRODUCING A CONVERSION ELEMENT, AND CONVERSION ELEMENT

(71) Applicants: Angela Eberhardt, Augsburg (DE); Christina Wille, Friedberg (DE)

(72) Inventors: Angela Eberhardt, Augsburg (DE); Christina Wille, Friedberg (DE)

(73) Assignee: OSRAM GMBH, Muenchen (DE)

(21) Appl. No.: 14/130,501

(22) PCT Filed: Jul. 4, 2012
(86) PCT No.: PCT/EP2012/063020

§ 371 Date: Jan. 2, 2014

(30) Foreign Application Priority Data
Jul. 5, 2011 (DE) 10 2011 078 689.9

(51) Int. Cl. C03C 17/34; C03C 4/12

(52) U.S. Cl. CPC C03C 17/3411; C03C 4/12
USPC 428/172; 65/33.1; 428/426; 428/323

(57) ABSTRACT

A method for producing a conversion element for an optical and/or optoelectronic component is provided. The method may include at least: providing a transparent substrate, applying a layer, which contains powdered glass solder, vitrifying the layer by a first temperature treatment, whereby the glass solder of the layer is vitrified and thus converted into a transparent glass material having little intrinsic coloration, applying a phosphor-containing material to the layer, and performing a second temperature treatment, whereby phosphor of the phosphor-containing material sinks into the glass material of the layer.

### RELATED APPLICATIONS

The present application is a national stage entry according to 35 U.S.C. §371 of PCT application No.: PCT/EP2012/063020 filed on Jul. 4, 2012, which claims priority from German application No.: 10 2011 078 689.9 filed on Jul. 5, 2011, and is incorporated herein by reference in its entirety.

### TECHNICAL FIELD

Various embodiments relate to a method for producing a conversion element, and a conversion element. Conversion elements are used in conjunction with optical or optoelectronic components for the purpose of changing the spectrum and therefore the perceived color impression of the electromagnetic radiation emitted by the component. A conversion element is attached for this purpose in front of the component, for example, a light-emitting semiconductor chip, such that the radiation emitted by the component passes through the conversion element. Phosphors in the conversion element set the colorimetric locus and the color temperature.

### BACKGROUND

Conventionally, a matrix material and a phosphor are mixed with one another during the production of a conversion element. Silicone is conventionally used as a matrix material. Silicone is a poor heat conductor, because of which the phosphor is then subjected to an elevated thermal stress and therefore loses efficiency during operation of the light-emitting component. Glass as a matrix material has the advantage of better heat conduction, since it is higher by a factor of 10 in comparison to silicone on average, whereby the phosphors heat up less in operation and thus are more efficient. On the other hand, high temperatures are necessary for embedding the phosphor particles in the case of the use of glass as a matrix, whereby the phosphor can be damaged during this process and can thus also permanently lose efficiency.

DE 10 2008 021 438 A1 proposes a method for producing a conversion element having glass matrix, in which a mixture of glass and phosphor is mixed, compacted, and sintered. During this method, relatively high temperatures are used (150° C. above the softening temperature). In addition, costly shaping methods must be used.

### SUMMARY

Various embodiments provide a conversion element and a cost-effective method for the production thereof, using which the efficiency of the conversion element is improved and using which glasses are also usable as a matrix material for a conversion element, with lower risk of production-related damage to the phosphors. In relation to the commercially available conversion elements, which contain silicone as a matrix material, improved heat dissipation during operation of the conversion element and thus improved efficiency of the phosphors are to be achieved.

In the method according to the present disclosure, a glass material is selected as a matrix for the phosphor, since it ensures particularly high heat dissipation in comparison to silicone, for example. Above all, however, the finally used material mixture is not subjected to the temperature treatment during the production process, as described in DE 10 2008 021 438 A1. Instead, a glass solder and a phosphor-containing material are used, which are successively subjected to various temperature treatment steps. Firstly, it is provided that a glass solder powder for the matrix material is subjected alone, i.e., still without phosphor, to a (first) temperature treatment. Temperature and duration of this first temperature treatment step are selected such that the vitrification of the phosphor-free glass solder occurs and therefore the glass solder powder layer is converted into a glassy layer which is preferably as free of pores as possible. In comparison to the sintering method mentioned at the beginning, the phosphor is not subjected to this first temperature treatment, so that the production of the preferably bubble-free glassy layer can also be performed at elevated temperatures.

Phosphor-containing material (for example, a solution or suspension which contains the phosphor) is first applied to the already vitrified material after this vitrification, in particular as a further layer. This layer sequence is then subjected to a further, second temperature treatment, due to which the phosphor of the phosphor-containing material sinks into the pre-vitrified layer, i.e., into the previously already vitrified layer.

One of the considerations utilized in this application is that the material to be subjected to the (second) temperature treatment must only be heated sufficiently that the phosphor can sink therein. This has the result that the phosphor is not provided homogeneously in the glass matrix, but rather tends to be concentrated on the opposing side to the substrate glass. This side preferably faces toward the chip (also in the case in which the conversion element is spaced apart therefrom), so that the phosphor is provided relatively close to the chip and in a lesser layer thickness than in the case of the sintering method. An improved emission characteristic is thus provided over the angle (for example, to avoid/reduce the so-called “yellow ring” in the case of partial conversion), since it is also dependent on the thickness of the converting layer (light exiting to the side).

In the case of the sintering method as described in DE 10 2008 021 438 A1, the phosphor particles, which are already added from the beginning, increase the viscosity and thus require a higher temperature to achieve a comparable level of bubbles or lack of bubbles. Even in the case of low-melting-point glasses, the stronger temperature action which is then required can potentially damage a fraction of the phosphor and permanently deactivate it. In the method proposed here, however, the production-related thermal stress of the phosphor is very much less than in the case of a sintering method by way of the performance of two separate temperature treatment steps (once with and once without phosphor) and also by way of the selected sequence of the method steps. An unintended (partial) deactivation of phosphor is therefore less probable in this method, even upon the use of lead-free glass solders, the softening temperatures of which are higher than those of lead-containing glass solders. This increases the usability of glass materials as a matrix material as an alternative to silicone. According to ISO 7884-3, the softening temperature is defined at a viscosity η=10^{7.6} dPa·s.

The above-described method steps are provided in conjunction with a transparent substrate, which is used as an underlay for the glass solder layer to be applied and is later part of, or in any case, a carrier of the finished conversion element.

The sinking-in of the phosphor from the phosphor-containing layer into the glass solder material underneath occurs in the direction toward the substrate (at the very bottom). The sinking-in procedure can be assisted and accelerated by utilizing the force of gravity and/or by mechanical pressing, respectively in conjunction with the heat action during the second temperature treatment. The transparent substrate (for example, made of glass) has a higher softening temperature than the glass solder layer to be applied. It can be used during the manufacturing as a foundation and buttress (or pressing plate) for the glass solder layer and furthermore serve as a simple optical element on the later conversion element. The actual conversion element then consists of the phosphor particles and the glass used as a matrix material.

The second temperature treatment can be performed at the same or a similar temperature (deviating by at most 100° C., preferably at most 50° C.) as the first temperature treatment. The temperature of the first temperature treatment is preferably higher than that of the second, since the phosphor is not yet also heated. The phosphor-free glass solder is already vitrified by the first temperature treatment step, before the phosphor sediments into the pre-vitrified layer. For the method according to the application, in particular glass solders for soft glasses and low-melting-point glasses (having softening temperatures of between 400 and 800° C., preferably between 400 and 600° C.), and even lead-free glasses or glass solders (having higher softening temperatures than lead-containing glasses) can be used, which are transparent, i.e., have a high transmission in the UV-visible range and little intrinsic coloration. The phosphor-free glass solder can be formed, for example, as a printable paste (for example, for screen printing or template printing) from glass solder powder, medium, and/or binder, and applied to the transparent substrate. The temperature treatment can be performed in air.

The phosphor-containing material can be applied as a paste suitable for printing or alternatively by spraying or spreading on (as a liquid or suspension), by electrostatic deposition (as a powder), or in another manner. The phosphor-containing material can contain the phosphor suspended, for example, in an organic solvent (such as isopropanol). The initially phosphor-free glass solder layer underneath can be, for example, an alkali-containing, zinc-containing, and/or boron-containing phosphate, a silicate, a borate, or a borosilicate, or can contain such a material as a main component. These materials do not have intrinsic coloration which changes the colorimetric locus. Above all, as has been shown, they do not react during the temperature treatment with the various types of phosphors (for example, garnets, for example, YAG:Ce, LuAG, etc., nitrides, SiONs, and/or orthosilicates), which are used to achieve the different spectral ranges of the secondary spectra (for example, for green, red, etc.). The colorimetric locus is set by mixing the phosphors. The primary radiation additionally also contributes in the case of the partial conversion. Warm white light can be generated, for example, by partial conversion of a blue-emitting chip using a mixture made of garnet and nitride and also by a mixture made of nitride and orthosilicate. Other light colors can also be produced by various combinations. It has proven to be advantageous here if all phosphor types can be embedded in the same glass matrix, without reacting therewith and thus being damaged. The method described here in combination with the above-mentioned lead-free glass solders is therefore particularly advantageous, because also the particularly sensitive nitrides and orthosilicates can be embedded in air and under normal pressure. The method thus becomes more cost-effective. In addition, other lead-free glass solders can also be used. Lead-free glass solders typically do have a higher softening temperature than lead-containing glass solders, but thanks to the method proposed here, they can now be processed with lower heat stress for the solders than in the case of admixture with the solder before performance of the vitrification. This substantially increases the practical usability of lead-free, RoHS (Restriction of Hazardous Substances)-conforming glass solders.

According to one refinement, an additional scattering layer is produced directly on the transparent substrate, before the initially phosphor-free material of the actual glass solder layer is applied. The paste of the scattering layer can initially be left unvitrified on the substrate and can be vitrified jointly with the initially phosphor-free glass solder by the first temperature treatment. Alternatively, a separate temperature treatment can also be performed beforehand, to initially individually vitrify the scattering layer. In the first case, two temperature treatments are necessary, in the latter case, three separate temperature treatments.

Several embodiments of the conversion element and the production thereof are set forth hereafter. Preferably, lead-free, but low-melting-point glass solders having softening temperatures between 400 and 600° C. are used. In particular, zinc-containing borate glasses, zinc-bismuth-borate glasses, aluminum phosphate glasses, aluminum-zinc-phosphate glasses, or an alkali phosphate glass, also in combination with one another and/or mixed with further additives, can be used for the (initially) phosphor-free layer. As the phosphor itself, for example, YAG (yttrium-aluminum garnet), nitrides, or also orthosilicates can be used. In addition, multiple different phosphors can also be used in combination with one another, to generate two or more different secondary spectra. The above-mentioned matrix materials do not have intrinsic coloration, so that independently of which phosphors are to be added in which concentration or mixture, the same composition of the embedding glass matrix can always be used. However, orthosilicates and nitrides are less chemically resistant and therefore are particularly susceptible to oxidation during the production-related thermal treatment, particularly at temperatures above 600° C. Even in the case of lead-containing glass solders such as PbO—B₂O₃—SiO₂, like the glass solders of the designations 10104 and 10012 of the producer Ferro, a reduced excitability of nitride and orthosilicate phosphors was observed with increasing sinking-in temperature. The method proposed here allows even oxidation-susceptible phosphors to be carefully introduced into a glass matrix, however.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIGS. 1A to 1G show various method steps of one type of embodiment of the method proposed here; and

FIGS. 2 to 7 show various embodiments of an arrangement having a conversion element and an optical or optoelectronic component.

### DETAILED DESCRIPTION

The following detailed description refers to the accompanying drawing that show, by way of illustration, specific details and embodiments in which the disclosure may be practiced.

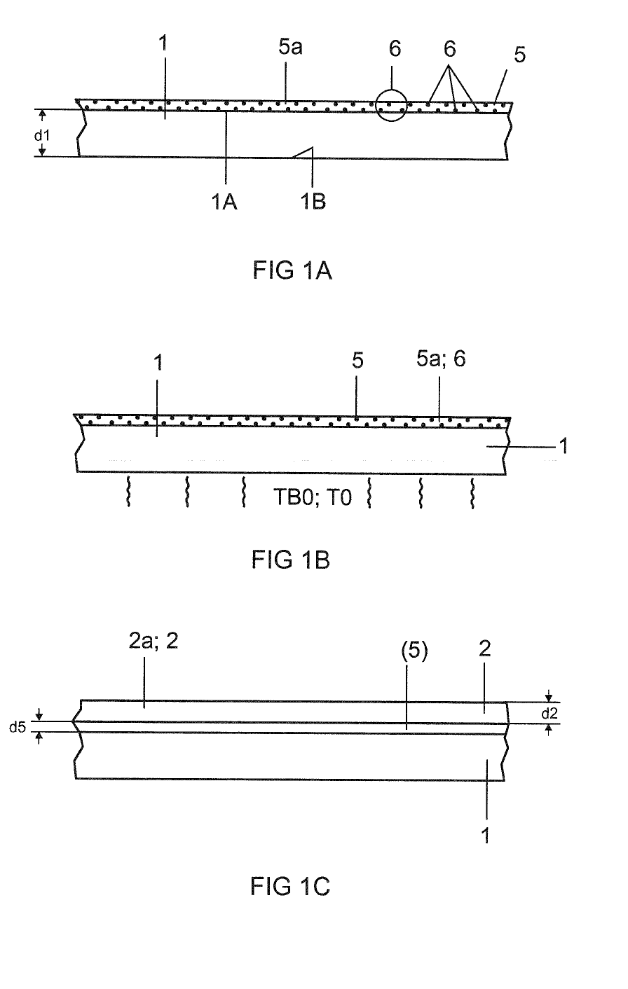

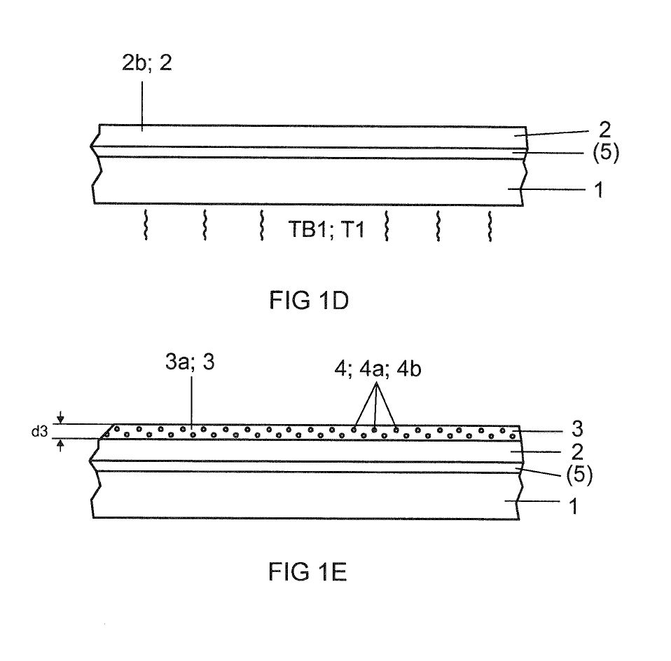

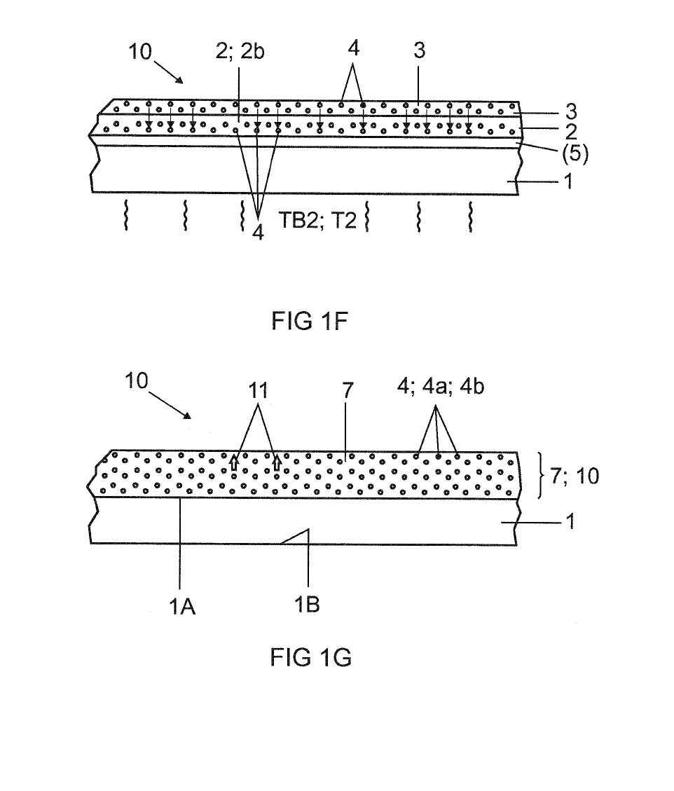

FIGS. 1A to 1G illustrate various method steps of an embodiment of the method, wherein respectively a schematic, partially cross-sectional view of a transparent substrate 1 and the further layers already arranged thereon is shown. The dimension ratios, in particular layer thickness ratios, are not to scale. The method steps according to FIGS. 1A and 1B are also optional and can therefore be omitted; accordingly, the layer 5 in FIGS. 1C to 1F can also be omitted. The actual method therefore begins with FIG. 1C, where a layer made of a glass solder 2a, which is initially still free of a phosphor, is deposited or applied in another manner—either directly to a transparent substrate 1 or (as shown) to an optional scattering layer 5 previously applied to the substrate 1.

According to one refinement, firstly this scattering layer 5 (FIG. 1A) is deposited directly onto the (preferably level and plane-parallel) transparent substrate 1 of the substrate or layer thickness d1 (of preferably between 10 μm and 5 mm). The scattering layer 5 preferably consists of a glass solder material 5a, which contains scattering particles 6 (FIG. 1A), in particular those having an index of refraction which differs significantly, preferably by at least 0.1, from that of the glass matrix, and/or having a particle size between 380 nm and 5 μm (as a mean particle diameter). After the application of the scattering layer 5 according to FIG. 1A, it can either be vitrified according to FIG. 1B by a separate temperature treatment or alternatively, after the application of a glass solder layer 2 according to FIG. 1C, it can subsequently be vitrified jointly with this glass solder layer 2, as indicated in FIG. 1D by the temperature treatment TB1 and the temperature T1. If the scattering layer 5 is first to be vitrified individually, according to FIG. 1B, firstly a separate temperature treatment TB0 is performed, the temperature T0 and duration of which will be described in greater detail hereafter.

According to FIG. 1C, a layer 2 made of a glass solder 2a is applied, which initially still does not contain phosphor. The layer 2 or the transparent substrate 1 covered with this layer (and optionally with the optional scattering layer 5 of the layer thickness d5) is subjected according to FIG. 1D to the (first) temperature treatment TB1; the values selected as examples for temperature T1 and duration of the temperature treatment TB1 will be described in greater detail hereafter. The layer thickness d2 of the layer 2 after performance of the first temperature treatment TB1 is, for example, between 1 μm and 200 μm, in particular between 5 μm and 100 μm. A layer thickness d2 between 10 μm and 50 μm is particularly preferred.

A deposition or another type of application of a phosphor-containing layer 3 (of a layer thickness d3) is finally performed, the phosphor-containing material 3a of which contains in particular a phosphor 4; 4a, 4b, which is distributed as particles or in another form. The phosphor-containing material is provided in particular as a phosphor powder, wherein the (mean) grain size can be between 2 μm and 20 μm, for example. As shown, multiple, for example, two types of phosphor particles 4a, 4b can be provided, for example, made of different materials or material combinations, to later generate multiple secondary spectra from the same primary spectrum of the optoelectronic component. Exemplary materials will be described at a later point in several exemplary embodiments with respect to the materials of the layer 2 made of glass solder 2a, the phosphor-containing layer 3 (i.e., the phosphor-containing material 3a and the phosphor 4 itself), and the optional scattering layer 5.

According to FIG. 1F, a second temperature treatment TB2 is now performed, which causes the phosphor 4 from the uppermost, phosphor-containing layer 3 to sink into the previously still phosphor-free layer 2, as shown in FIG. 1F on the basis of the arrows oriented downward. The glass solder 2a of the layer 2 was already vitrified during the first temperature treatment TB1 according to FIG. 1D. Therefore, according to FIG. 1E and at the beginning of the second temperature treatment TB2 according to FIG. 1F, the layer 2 is provided as a vitrified material. As for FIGS. 1B and 1D, exemplary temperatures T2 and durations will also be described at a later point for the temperature treatment TB2 according to FIG. 1F. Preferably, TB2 (sinking in)≦TB1 (glass solder).

After performance of the second temperature treatment TB2, the conversion element 10 shown in FIG. 1G results, which now includes a phosphor-containing glass layer 7, which is arranged directly on or at least above the transparent substrate 1 (the optional scattering layer 5 is not shown in FIG. 1G, since it can also be omitted). The conversion element 10 now contains phosphor 4; 4a, 4b, which was subjected to a more gentle temperature treatment and in particular a substantially lower thermal budget than had to be accepted heretofore upon use of a glass matrix. The phosphor is therefore completely activatable with higher reliability during later use.

The conversion element 10 produced on a first main surface 1A (FIGS. 1A to 1G) has a homogeneous (or alternatively also inhomogeneous) phosphor distribution in the lateral direction, which is preferably inhomogeneous in the direction perpendicular to the main surface 1A and in particular decreases with increasing proximity to the first main surface 1A. Accordingly, the gradient 11 of the phosphor concentration shown in FIG. 1G (see the two arrows in FIG. 1G) points away from the first main surface 1A and toward the opposing surface of the conversion element 10, which is still further away from the other main surface 1B of the transparent substrate 1. The phosphor concentration in the conversion element 10 is therefore greatest close to the surface of the conversion element 10 shown on top in FIG. 1G; this surface preferably faces toward the optical or optoelectronic component later, when the conversion element including the substrate is installed.

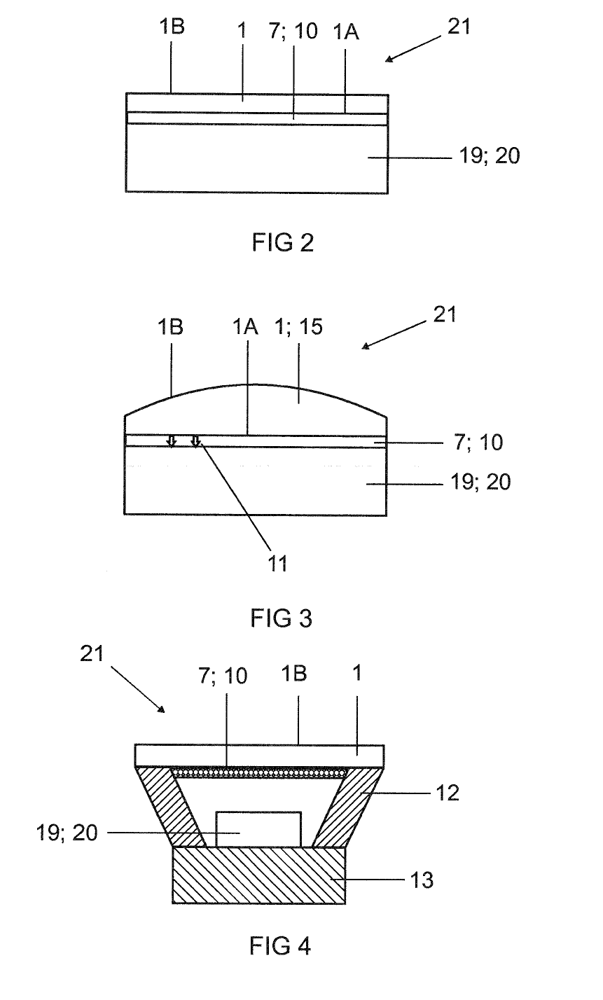

FIGS. 2 to 7 show several exemplary constructions of an arrangement 21 which, in addition to the proposed conversion element 10 and the substrate 1, which was used for the production and shaping thereof, has a component 20, specifically an optical and/or optoelectronic component 20. The component 20 is preferably a semiconductor chip 19, the light exit surface of which faces toward the conversion element 10. The conversion element 10 can be installed with the phosphor-containing side thereof directly on the light exit surface of the semiconductor chip 19 or component 20. As shown in FIG. 2, the conversion element 7; 10, like the transparent substrate 1, can be molded plane-parallel and having a constant layer thickness. The substrate is used here as a simple optical element.

Alternatively, according to FIG. 3, the transparent substrate 1 can also serve as an optical element, in particular as a lens 15, and therefore have a variable thickness over its cross-section. If the phosphor concentration 11 in the conversion element 10 is inhomogeneous and becomes greater with increasing distance from the main surface 1A of the substrate 1, this has the advantage that the radiation emitted by the component 20 is already incident on a majority of the phosphor in the conversion element 10 very close to the light exit surface thereof.

According to FIG. 4, the unit formed from the transparent substrate 1 and the conversion element 10 (or its phosphor-containing glass layer 7) can also be installed spaced apart from the component 20 or the semiconductor chip 19. For this purpose, a reflector 12 is provided as an example according to FIG. 4, which ensures a predefined distance between a carrier element 13, which bears the semiconductor chip 19, and an outer edge of the transparent substrate 1. The phosphor-containing side preferably also faces toward the component 20 here.

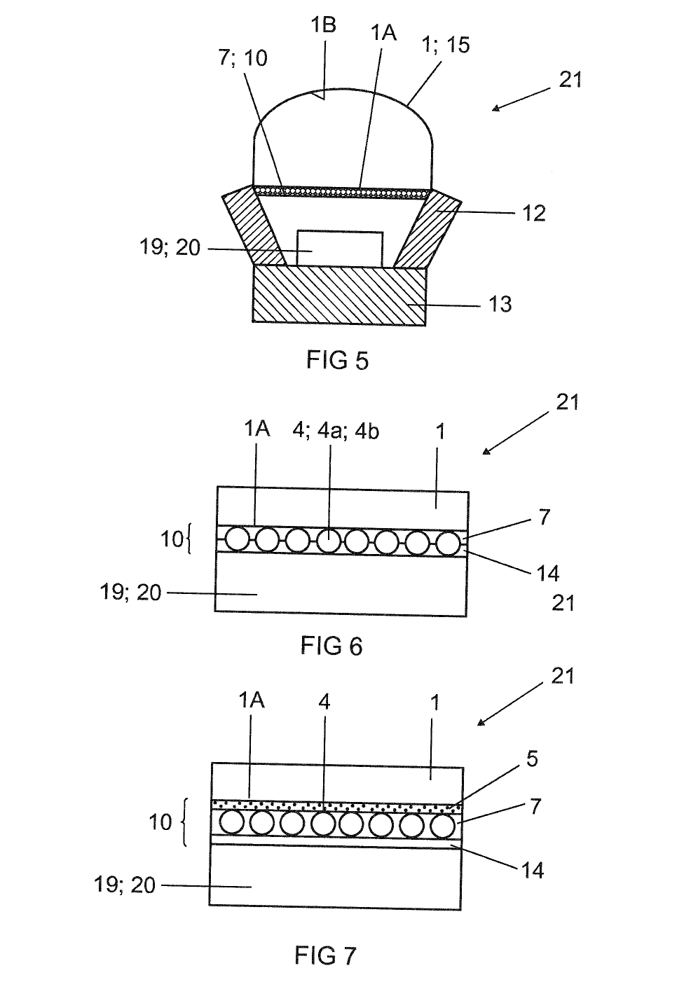

According to FIG. 5, the transparent substrate 1 may also be configured as an optical lens 15 in this arrangement 21. While the first main surface 1A, which is required as a foundation for the production of the conversion element 10, is preferably level, the opposing main surface 1B of the transparent substrate 1 can be curved and thus allow the shaping of the transparent substrate 1 as a lens 15.

FIGS. 6 and 7 show refinements, in which the phosphor-containing glass layer 7, which resulted by introduction of the phosphor into the original layer 2, is thinner (in any case after the performance of all temperature treatment steps) than the particle diameter of the phosphor 4. Therefore, very thin glass solder layers can also be applied during the production in the scope of FIGS. 1A to 1G, which no longer entirely enclose the phosphor particles 4. Although the layer thickness of the vitrified layer is then less than the mean or maximum diameter of the phosphor particles, the layer thickness is at least sufficiently great so that the phosphor particles 4 adhere fixedly on the substrate 1. The protruding, rising part of the phosphor particles 4 (on the bottom in FIG. 6) can then be levelled by an adhesive 14 (which is preferably inorganic and/or has a high index of refraction) and can also be glued directly to the light exit surface of the optical or optoelectronic component 20. A further, third temperature treatment can additionally be used during the gluing. For example, low-melting-point glasses having a softening temperature below 500° C. can be used as an inorganic adhesive.

FIG. 7 shows a refinement in which the phosphor-containing glass layer 7 has at least the layer thickness of the average particle size of the phosphor 4, but additionally a layer made of adhesive 14 is provided, similarly as in FIG. 6. In addition, a scattering layer 5 is provided, which was produced according to FIGS. 1A and 1B, for example. The scattering layer 5 is used for the purpose of achieving better homogeneity of the colorimetric locus or the mixed color over the light-exit-side angle range of the conversion element 10 (or the unit made of substrate and conversion element). In the embodiments of FIGS. 2 to 7, preferably precisely one single component 20 or one single semiconductor chip 19 is installed and associated with the conversion element 10 and/or the transparent substrate 1. Alternatively, a plurality of components, for example, a plurality of semiconductor chips having identical or different emission spectra, can be installed and associated with the conversion element, i.e., arranged underneath it.

The index of refraction of the scattering particles of the scattering layer 5 is preferably at least 0.1 greater or less than that of the glass material. The grain size of the scattering particles can be in the range of the wavelength of visible light or above it, for example, greater than 380 nm and less than 5 μm. For example, Al₂O₃, TiO₂, SrO, BaO, Y₂O₃, ZrO₂, La₂O₃, HfO₂, Ta₂O₃, SnO₂, ZnO, Nb₂O₃, rare earth oxides, or arbitrary combinations of these materials can be used as a material for the scattering particles 6 of the scattering layer 5. For example, an aluminum oxide powder of the designation CR1-CR30 of the producer Baikowski can be contained in a quantity of between 2 and 10, preferably 5 vol.-% in the original glass solder powder for the scattering layer 5.

Several embodiments are described in greater detail hereafter with respect to the materials used in the performance of the temperature treatment steps. The following embodiments are respectively combinable with the embodiments described hitherto in the description and with the embodiments of the drawings and the patent claims, since it refines them.

According to a first embodiment, for the layer 2, glass solder powder of the designation F010307 of the producer Heraeus is processed with medium and binder to form a paste which can be screen printed or template printed. For example, the glass solder, which contains the components alkali oxide-ZnO—Al₂O₃—B₂O₃—P₂O₅ can be used as a glass solder paste and can be applied as a layer 2, for example, onto a glass slide (producer Roth) or another (plane-parallel) glass plate. The paste is applied with a layer thickness d2 of, for example, 30 to 70 μm, in particular 50 μm, and heated during the first temperature treatment to a temperature between 400 and 800° C., preferably between 500 and 700° C. The temperature treatment can be performed, for example, for a duration of 10 to 60 minutes, preferably 20 to 40 minutes, either in air or with air exclusion. The vitrification occurs under normal pressure (1013 mbar). The layer thickness d2 of the layer 2 can also be selected differently, however; it can be, after performance of the first temperature treatment TB1, for example, between 1 μm and 200 μm, in particular between 5 μm and 100 μm, and particularly preferably between 10 μm and 50 μm.

Subsequently, for example, a garnet such as YAG:Ce, LuAG, etc., a nitride, a SiON, or an orthosilicate can be applied as a phosphor, for example, by painting on a corresponding phosphor suspension in isopropanol or another medium. A second temperature treatment is then performed, also between 400 and 800° C., preferably between 500 and 700° C. (ideally below 600° C.) for the sinking-in or sedimentation of the phosphor, again for 10 to 60 minutes, preferably 20 to 40 minutes (for example, in air). The already vitrified layer becomes sufficiently soft during the second temperature treatment that the phosphor can sink therein. The proposed method therefore provides a conversion element, the phosphors of which are completely activatable with higher probability after manufacturing of the conversion element.

In a second embodiment, glass solder powder of the designation 106038D of the producer Ferro (a glass solder compound of the system ZnO—B₂O₃—SiO₂, i.e., zinc-containing borate glass) is applied as a paste to the transparent glass substrate and firstly heated at a temperature between 500 and 800° C., preferably between 550 and 650° C., for a duration of 10 to 60 minutes, preferably 20 to 40 minutes in air. After this vitrification, the phosphor is applied as in the first exemplary embodiment, before, for the sinking in, the second temperature treatment is performed, also at a temperature between 500 and 800° C., preferably between 550 and 650° C. (ideally below 620° C.) for 10 to 60 minutes, preferably 20 to 40 minutes (for example, in air under normal pressure of 1013 mbar).

In a third embodiment, glass solder powder of the designation 8474 of the producer Schott (an alkali phosphate glass solder) is applied similarly as in the first exemplary embodiment and firstly heated to a temperature between 400 and 600° C., preferably between 450 and 550° C., for a duration of 10 to 60 minutes, preferably 20 to 40 minutes in air. After this vitrification, phosphor is added as in the first embodiment, before the sinking-in procedure is caused by the second temperature treatment at temperatures also between 400 and 600° C., preferably between 450 and 550° C. (ideally below 500° C.) for a duration of 10 to 60 minutes, preferably 20 to 40 minutes in air under normal pressure (1013 mbar).

In all three embodiments, the sunken-in phosphors are still completely activatable after the (second) temperature treatment. The phosphor can respectively also be applied suspended in organic solvents such as isopropanol, instead of as a paste. The phosphor-containing side of the finished conversion element 10 preferably faces toward the light exit surface of the optoelectronic element 20 or the semiconductor chip 19 during the later installation. If the phosphor is applied as a paste (in conjunction with a binder and a solvent), this paste can contain nitrocelluloses, acrylates, or ethylcelluloses. The phosphor-containing material can also be applied by spraying, painting, or electrostatic deposition, in addition to being printed on (in particular by screen printing or template printing).

For the layer 2 made of glass solder, glass solders having a coefficient of thermal expansion a, for example, between 6×10⁻⁶/K and 20×10⁻⁶/K (with respect to the temperature range between 20 and 300° C.) can be used.

The performance of the method proposed here at sinking-in temperatures below 700° C., preferably below 600° C. under normal pressure allows embedding of even sensitive phosphor types, such as the nitrides or (ortho-)silicates, even in the presence of air. The second temperature treatment or optionally also both temperature treatments can also be performed in vacuum, in a protective gas, or in a reducing atmosphere, which makes the production method more costly, however. Preferably, TB2 (sinking in)≦TB1 (glass solder).

According to a further, fourth embodiment, firstly the deposition of a scattering layer 5 is provided. This can contain, in addition to the glass solder powder (for example, of the designation F010307 of the producer Heraeus) a powder made of particles having a high refractive index, preferably having grain sizes greater than 380 nm. For example, an aluminum oxide powder (Al₂O₃), for example, of the designation CR1-CR30 of the producer Baikowski can be added and mixed therewith. The powder mixture, which is then homogeneous, is processed with medium and binder to form a printable paste and applied to the transparent substrate. After the first temperature treatment, a layer thickness d5 of between 1 μm and 70 μm, preferably of 50 μm, results for this purpose.

The further processing steps as in the first three embodiments only follow after the application of this scattering layer, specifically the application of the actual, initially phosphor-free glass solder, the first temperature treatment, the application of the phosphor-containing material, and the second temperature treatment. During the first temperature treatment, the scattering layer and the initially phosphor-free glass solder layer are then jointly pre-vitrified. Alternatively, the scattering layer can also firstly be pre-vitrified alone on the substrate. The temperature T0 and/or the duration can be selected similarly as for the following temperature treatments TB1 and/or TB2 or also deviating therefrom. The separate heating process for the scattering layer then requires three temperature treatments for the production method as a whole, however.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A method for producing a conversion element for an optical and/or optoelectronic component, comprising:
providing a transparent substrate,
applying a layer, which contains powdered glass solder,
vitrifying the layer by a first temperature treatment, whereby the glass solder of the layer is vitrified and thus converted into a transparent glass material having little intrinsic coloration,
applying a phosphor-containing material to the layer, and
performing a second temperature treatment, whereby phosphor of the phosphor-containing material sinks into the glass material of the layer.

2. The method as claimed in claim 1,
wherein the second temperature treatment is performed at a temperature which deviates by at most 50° C. from a temperature at which the first temperature treatment is performed, or is identical to the temperature of the first temperature treatment, wherein the respective temperature is respectively between 400 and 800° C., and wherein the duration of the first and second temperature treatment is respectively between 5 and 90 minutes.

3. The method as claimed in claim 1,
wherein the phosphor-containing material has a phosphor or a mixture of various phosphors, which are distributed homogeneously in the phosphor-containing material, and the phosphor-containing material is applied in said applying the phosphor-containing material to the entire area of the layer.

4. The method as claimed in claim 1, wherein, in said applying the layer, a lead-free, but low-melting-point glass solder, which has a softening temperature of between 400 and 600° C., is applied as a glass solder.

5. The method as claimed in claim 1, wherein, after said providing, a glass solder material, which contains scattering particles, is applied as a scattering layer directly to the transparent substrate, before said applying the layer is performed.

6. The method as claimed in claim 5,
wherein the scattering layer made of the glass solder material containing the scattering particles is heated in said vitrifying jointly with the layer applied in said applying the layer and vitrified.

7. The method as claimed in claim 5,
wherein the scattering layer made of the glass solder material containing the scattering particles is already vitrified before said applying the layer by a separate temperature treatment.

8. The method as claimed in claim 1, wherein powdered phosphor is applied in said applying the phosphor-containing material as a phosphor-containing material.

9. The method as claimed in claim 1, wherein the phosphor-containing material is applied in said applying the phosphor-containing material by spraying or spreading on, by electrostatic deposition, or by printing as a paste.

10. A conversion element for an optical and/or optoelectronic component, comprising:
a transparent substrate,
a layer made of a glass material, wherein the layer is arranged on or above a main surface of the transparent substrate and is fixedly connected to the transparent substrate,
wherein the layer made of the glass material contains phosphor,
wherein the layer made of the glass material completely or nearly completely covers the one main surface of the transparent substrate, while in contrast another, opposing main surface of the transparent substrate is exposed,
wherein the phosphor is distributed over the entire extension of the layer made of the glass material in this layer, and
wherein the concentration of the phosphor in the layer made of the glass material varies over the layer thickness of this layer and decreases in the direction toward the transparent substrate.

11. The conversion element as claimed in claim 10, wherein, between the layer made of the glass material and the transparent substrate, a scattering layer is arranged, which contains scattering particles.

12. The conversion element as claimed in claim 10, wherein the layer made of the glass material contains as a main component a lead-free, but low-melting-point glass having a softening temperature of between 400 and 600° C.

13. The conversion element as claimed in claim 10,
wherein
the conversion element is installed on an optical and/or optoelectronic component,
wherein the layer, which contains the phosphor, made of the glass material is either fastened on the component, or installed spaced apart from the component and
wherein the layer, which contains the phosphor, made of the glass material faces toward the component.

14. The conversion element as claimed in claim 10,
wherein the glass material contains one or more of the phosphor types garnet, nitride, and orthosilicate.

15. The conversion element as claimed in claim 10,
wherein the transparent substrate is molded such that it is configured either plane-parallel and having constant layer thickness or alternatively is molded as a lens having varying thickness.

16. The method as claimed in claim 4,
wherein the glass solder is a zinc-containing borate glass, a zinc-bismuth-borate glass, an aluminum phosphate glass, an aluminum-zinc-phosphate glass, or an alkali phosphate glass.

17. The method as claimed in claim 5,
wherein the scattering particles have a particle diameter between 380 nm and 5 μm and/or have an optical index of refraction which differs by at least 0.1 from the index of refraction of the glass matrix.

18. The conversion element as claimed in claim 11,
wherein the scattering particles have a particle diameter between 380 nm and 5 μm and/or have an index of refraction which differs by at least 0.1 from the index of refraction of the glass matrix.

19. The conversion element as claimed in claim 12,
wherein the layer made of the glass material contains a zinc-containing borate glass, a zinc-bismuth-borate glass, an aluminum phosphate glass, an aluminum-zinc-phosphate glass, or an alkali phosphate glass.
